(19) United States
(12) Patent Application Publication
(10) Pub. No.: US 2015/0249637 A1
(43) Pub. Date: Sep. 3, 2015

(54) COMMUNICATIONS APPARATUS AND METHOD

(71) Applicant: IMP HOLDING LIMITED, Penicuik, Lothian (GB)

(72) Inventors: Bonnie Lawson-Brown, Penicuik (GB); Martin Alderson, Penicuik (GB)

(21) Appl. No.: 14/432,749

(22) PCT Filed: Sep. 27, 2013
(86) PCT No.: PCT/GB2013/052522

§ 371 Date: Mar. 31, 2015

(30) Foreign Application Priority Data
Oct. 1, 2012 (GB) 1217527.9

(51) Int. Cl. H04L 29/12; G06Q 30/02; H04W 8/26; H04L 12/28; H04W 48/14

(52) U.S. Cl. CPC H04L 61/2038; H04L 12/2852; H04L 12/2854; H04W 48/14; H04W 8/26; G06Q 30/0267; H04W 84/12

(57) ABSTRACT

The present invention relates to communications apparatus (10). The communications apparatus (10) comprises server apparatus (16) comprised in a metropolitan or wide area network. The server apparatus (16) is configured to store a plurality of unique identifiers and a plurality of different data records with each data record corresponding to a respective unique identifier. The communications apparatus (10) also comprises personal computing apparatus (32) configured to communicate with: the server apparatus (16) by way of the metropolitan or wide area network; and an access point (24, 26, 28, 30) comprised in a wireless local area network (WLAN) (20, 22). The personal computing apparatus (32) is operative to receive a unique identifier from the access point (24, 26, 28, 30) and to transmit the unique identifier to the server apparatus (16). The server apparatus (16) is operative to select a data record corresponding to the received unique identifier and to transmit the selected data record to the personal computing apparatus (32).

### FIELD OF THE INVENTION

The present invention relates to communications apparatus and methods of communication using such apparatus in particular but not exclusively for advertising.

### BACKGROUND TO THE INVENTION

Advertising is a long used form of communication for marketing goods and services. Advances in technology and in particular in communications technology have been and continue to be adopted by advertisers. In the past, the most efficient means of advertising was to reach as much of the mass market as possible, such as by way of newspapers and broadcasting. More recently advertising has become more sophisticated as advertisers attempt to reach smaller audiences for whom the goods or services on offer have greater appeal than the mass market. Approaches to such targeting advertising include selecting a target group on the basis, for example, of consumer profiles or configuring advertisement content and form of delivery to suit a particular target group. Technology and market intelligence have made a significant contribution to the effectiveness of targeted advertising.

The present inventors have become appreciative of certain shortcomings of present approaches to the application of technology in targeted advertising. The present invention has been devised in the light of the inventors' appreciation of such shortcomings. An object for the present invention is therefore to provide improved communications apparatus which is configured to deliver data, such as information, to an operator of personal computing apparatus. It is a further object for the present invention to provide a communications method to deliver data, such as information, to an operator of personal computing apparatus.

### STATEMENT OF INVENTION

According to a first aspect of the present invention there is provided communications apparatus comprising:
server apparatus comprised in a metropolitan or wide area network, the server apparatus being configured to store a plurality of unique identifiers and a plurality of different data records, each data record corresponding to a respective unique identifier; and
personal computing apparatus configured to communicate with: the server apparatus by way of the metropolitan or wide area network; and an access point comprised in a wireless local area network (WLAN),
the personal computing apparatus being operative to receive a unique identifier from the access point and to transmit the unique identifier to the server apparatus, and the server apparatus being operative to select a data record corresponding to the received unique identifier and to transmit the selected data record to the personal computing apparatus.

In use, personal computing apparatus, such as a smartphone, receives a unique identifier from an access point of a wireless local area network (WLAN). The wireless local area network may, for example, be present in a retail outlet. Reception of the unique identifier by the personal computing apparatus shows the personal computing apparatus to be near the access point. According to a first example and where the wireless local area network is located in a retail outlet, the reception of the unique identifier shows the personal computing apparatus to be near or in the retail outlet. According to a second example and where the wireless local area network is located in a particular part of a mass public entertainment venue, the reception of the unique identifier shows the personal computing apparatus to be in that part of the venue. The reception of the unique identifier may show the personal computing apparatus to be in a particular locale. The personal computing apparatus is operative to transmit the received unique identifier to the server apparatus by way of a metropolitan or wide area network, such as by way of the Global System for Mobile Communications (GSM) network. The WLAN and the metropolitan or wide area network therefore constitute different communications channels with the personal computing apparatus being configured to communicate by way of both communications channels. A server apparatus comprised in the metropolitan or wide area network stores a plurality of unique identifiers and a plurality of different data records with each data record corresponding to a respective unique identifier. According to the first example the server apparatus may store plural unique identifiers, each of which corresponds to a different location, and corresponding different advertisements. According to the second example the server apparatus may store plural unique identifiers, each of which corresponds to a different part of the entertainment venue, and corresponding different public information messages. Upon reception of the unique identifier the server apparatus is operative to select the data record corresponding to the received unique identifier and to transmit the selected data record to the personal computing apparatus. According the first example the selected data record may be an advertisement appropriate for delivery to the retail outlet where the wireless local area network is located. According to the second example the selected data record may be a public information message appropriate for delivery to a particular location in the entertainment venue, such as directions as to where persons at that location should vacate the venue so as to provide for orderly emptying of the venue at the end of an entertainment event.

Each data record may comprise information comprehensible to an operator of the personal computing apparatus. As described by way of example above the information may be of the form of an advertisement or public information message. The personal computing apparatus may comprise an output device and the personal computing apparatus may be configured to provide the information comprised in a data record to an operator by way of the output device. The output device may comprise a display. The information may therefore comprise graphical data which may be seen and comprehended by the operator.

The communications apparatus may further comprise the access point. More specifically the communications apparatus may comprise the wireless local area network (WLAN) comprising the access point. The access point may be operative to transmit the unique identifier. The unique identifier as transmitted by the access point may be comprised in a wireless management message. The access point may be operative to transmit the wireless management message as part of an identity discovery process. An identity discovery process may precede an authentication process. According to one approach the access point may be operative to transmit a beacon comprising the unique identifier. According to another approach the personal computing apparatus may be operative to transmit a probe request message and the access point may be operative upon reception of the probe request message to transmit a probe response message comprising the unique identifier. Upon reception of the unique identifier the personal computing apparatus may have no need to increase an extent of engagement with the access point beyond the identity discovery process. The personal computing apparatus may therefore be operative such that there is no authentication process or association process with the access point. Authentication and association are normally required before there is an exchange of data messages between an access point and station. Nevertheless the personal computing apparatus may be operative to receive the unique identifier on plural occasions whereby the personal computing apparatus may determine whether or not it is within range of the wireless local area network.

The unique identifier may be a physical address for the access point, such as a burned in address assigned by the manufacturer of the access point. The unique identifier may comprise at least one of a Media Access Control (MAC) address and a Service Set Identifier (SSID). A beacon message or probe response message may comprise one, other or both of a MAC address and a SSID. The personal computing apparatus may therefore be operative to send at least one of a Media Access Control (MAC) address and a Service Set Identifier (SSID). The sending of an SSID to the server apparatus may be advantageous, for example, where an operator has multiple access points which have their own MAC addresses and which belong to the same wireless local area network or interconnected local area networks. The wireless local area network may therefore comprise plural wireless access points and each wireless access point may be operative to transmit an identifier comprising an SSID, the SSID being common to all identifiers transmitted by the wireless local area network.

The communications apparatus may be configured such that one of the personal computing apparatus and the access point may be mobile. More specifically one of the personal computing apparatus and the access point may be mobile and the other may be immobile such that it is incapable of being moved. According to one embodiment, the personal computing apparatus may be mobile and the access point may be immobile. In this embodiment the access point may, for example, be installed in or near a building. The personal computing apparatus may be moved into range of the wireless local area network by, for example, being carried by hand by an operator of the personal computing apparatus. According to another embodiment, the personal computing apparatus may be immobile and the access point may be mobile. In this embodiment the access point may, for example, be installed on a vehicle which moves around to thereby deliver data records to personal computing apparatus as the personal computing apparatus comes into range of the mobile access point.

The metropolitan or wide area network may be wireless. The personal computing apparatus may be configured for wireless communication with the metropolitan or wide area network. The metropolitan or wide area network may comprise a telecommunications network. The telecommunications network may be a cellular network and more specifically a mobile phone network, such as GSM, GPRS, CDMA, EV-DO, EDGE or the like. In certain embodiments the metropolitan or wide area network may be wired. The personal computing apparatus may be configured for wired communication with the metropolitan or wide area network, such as by way of an ohmic conductor or an optical conductor. In such embodiments the personal computing apparatus may be immobile as described above.

The personal computing apparatus may be configured to be mobile, such as hand portable. The personal computing apparatus may be a mobile device, such as a mobile phone, a Personal Digital Assistant (PDA), a tablet computer, a laptop or the like. In certain embodiments where the personal computing apparatus is immobile, the personal computing apparatus may be embodied in a general purpose computer, such as a Personal Computer (PC).

The wireless local area network (WLAN) may be configured in accordance with an IEEE 802.11 standard, such as IEEE 802.11n. The personal computing apparatus may be configured to communicate with the access point in accordance with an IEEE 802.11 standard.

The personal computing apparatus may be operative in dependence on execution of a set of program instructions comprised in the personal computing apparatus. The set of program instructions may be comprised in an application program stored in the personal computing apparatus. The application program may be provided to an operator of the personal computing apparatus by an operator of the server apparatus.

The personal computing apparatus may be configured, e.g. by way of an application program, to determine at least one characteristic of data records to be received in the personal computing apparatus from the server apparatus. More specifically the at least one characteristic may be determined in dependence on user operation of the personal computing apparatus. For example the user may enter user profile information, such as age and sex, with the profile information being used by the server apparatus to determine which data record or records to transmit to the personal computing apparatus. The personal computing apparatus may therefore be operative to convey the profile information to the server apparatus. The server apparatus may be operative to select at least one data record in dependence on the received profile information. Alternatively or in addition the personal computing apparatus may be configured to allow for reception of at least one data record from a specific server apparatus operator. For example an operator of the personal computing apparatus may chose to receive data records from one or more specified retailers. The personal computing apparatus may be operative to convey a data record preference to the server apparatus and the server apparatus may be operative to decide whether or not to transmit a data record in dependence on the data record preference. The data store of the server apparatus may be configured to store data relating to each of plural personal computing apparatus. For example the data stored for each may comprise at least one of profile information and a data record preference.

According to a second aspect of the present invention there is provided a communications method comprising:
storing a plurality of unique identifiers and a plurality of different data records in server apparatus comprised in a metropolitan or wide area network, each data record corresponding to a respective unique identifier;
receiving in personal computing apparatus a unique identifier from an access point comprised in a wireless local area network (WLAN),
transmitting the unique identifier from the personal computing apparatus to the server apparatus by way of the metropolitan or wide area network;
selecting in the server apparatus a stored data record corresponding to the received unique identifier; and
transmitting the selected data record from the server apparatus to the personal computing apparatus.

Embodiments of the second aspect of the present invention may comprise one or more features of the first aspect of the present invention.

According to a third aspect of the present invention there is provided a computer program comprising program instructions for causing the server apparatus and the personal computing apparatus to perform the method according to the second aspect of the present invention.

The computer program may comprise a first set of program instructions for causing the server apparatus to perform a part of the method and a second set of program instructions for causing the personal computing apparatus perform another part of the method. The method may further comprise receiving the second set of program instructions in the personal computing apparatus. More specifically the method may comprise initiating the reception of the second set of program instructions in the personal computing apparatus by scanning a code, such as a QR code. The personal computing apparatus may therefore be configured to scan the code and to download the second set of program instructions in dependence on scanning the code. When downloaded the second set of program instructions may constitute an application program stored in the personal computing apparatus.

The computer program may be at least one of: embodied on a record medium; embodied in a read only memory; stored in a computer memory; and carried on an electrical carried signal. Further embodiments of the third aspect of the present invention may comprise one or more features of the first or second aspect of the present invention.

According to a further aspect of the present invention there is provided communications apparatus comprising: server apparatus comprised in a communications network, the server apparatus being configured to store a plurality of unique identifiers and a plurality of different data records, each data record corresponding to a respective unique identifier; and a station configured to communicate with: the server apparatus by way of the communications network; and an access point comprised in a wireless network, the station being operative to receive a unique identifier from the access point and to transmit the unique identifier to the server apparatus, and the server apparatus being operative to select a data record corresponding to the received unique identifier and to transmit the selected data record to the station.

The station may comprise computing apparatus such as personal computing apparatus. The communications network may comprise a metropolitan or wide area network. The communications apparatus may further comprise a wireless network comprising the access point, which is operative to transmit the unique identifier. The wireless network may comprise a wireless local area network. Further embodiments of the further aspect of the present invention may comprise one or more further features of the first aspect of the present invention.

### BRIEF DESCRIPTION OF DRAWINGS

The present invention will now be described by way of example only with reference to the following drawings, of which:

FIG. 1 is a block diagram representation of communications apparatus according to the present invention; and

FIG. 2 is a flow chart representation of a communications method according to the present invention.

### DESCRIPTION OF EMBODIMENTS

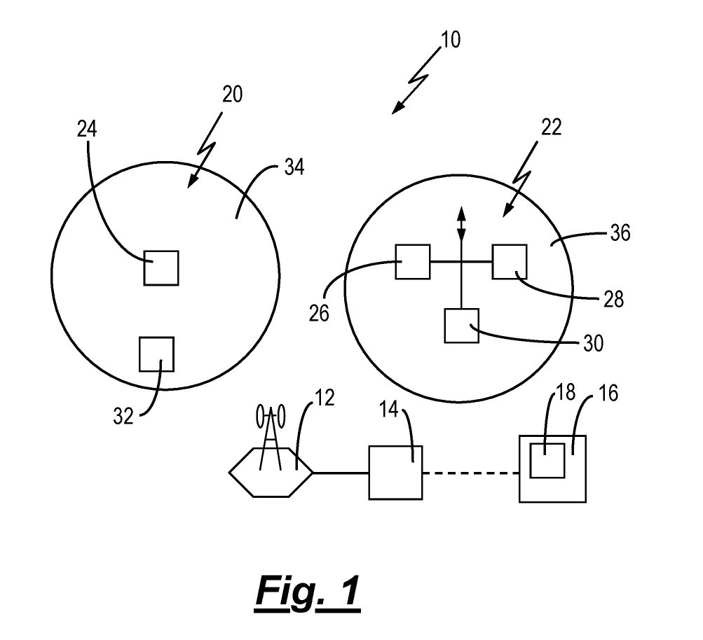

Communications apparatus 10 according to the present invention is represented in block diagram form in FIG. 1. The communications apparatus 10 comprises a base transceiver station 12 and a base station controller 14 which together form part of a Global System for Mobile Communications (GSM) network. The GSM network constitutes a metropolitan or wide area network. A server apparatus 16 is in data communication with the GSM network. The server apparatus 16 comprises a data store 18 of conventional form, which is operative to store plural Media Access Control (MAC) addresses and/or Service Set Identifiers (SSIDs) (which constitute unique identifiers) and a plurality of different data records with each data record corresponding to a respective MAC address or SSID. The MAC addresses, SSIDs and data record are stored in the like of a look up table. The communications apparatus 10 further comprises a first wireless local area network (WLAN) 20 and a second WLAN 22. The first and second WLANs 20, 22 are configured to be operable in accordance with the IEEE 802.11n standard. The first WLAN 20 has one wireless access point (WAP) 24 and the second WLAN 22 has first, second and third WAPs 26, 28, 30. The communications apparatus also comprises a smartphone 32 (which constitutes personal computing apparatus). An effective range of the first WLAN 20 is indicated by a first circle 34 and an effective range of the second WLAN 22 is indicated by a second circle 36.

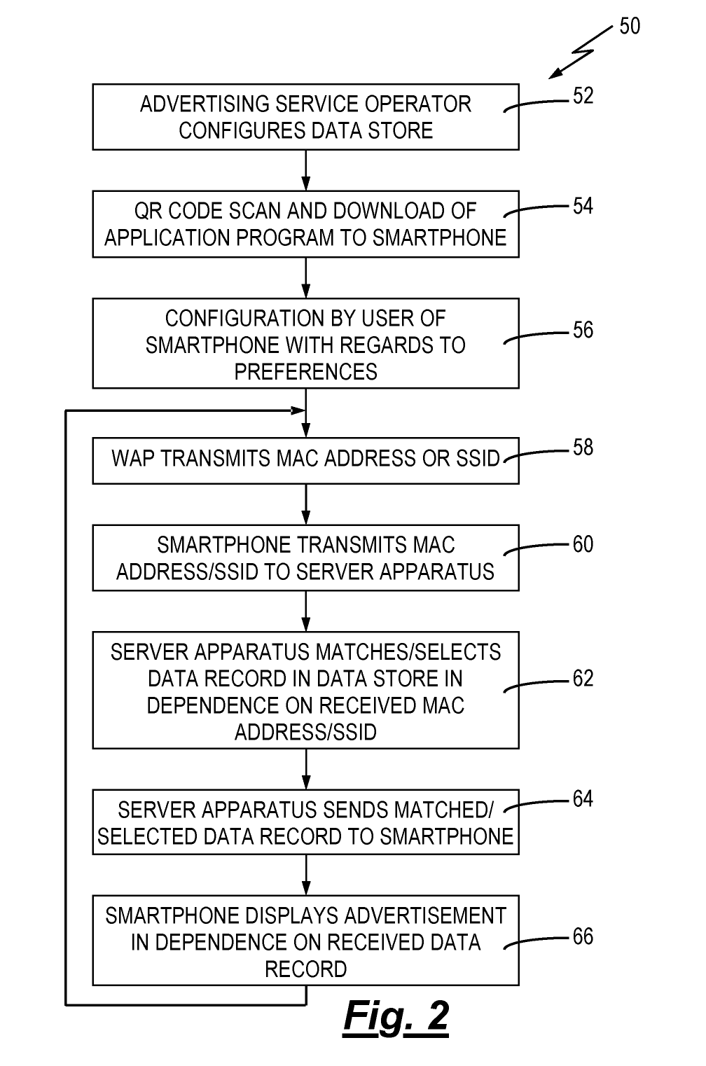

Operation of the communications apparatus 10 of FIG. 1 will now be described with reference to FIG. 2, which represents the main operational steps in flow chart form 50. An operator of an advertising service configures the server apparatus 16 such that the data store 18 contains a list of pairs of MAC addresses or SSIDs and data records in the form of a look up table 52. Each data record contains marketing information or links to marketing information for a particular retail outlet or retail chain. Where a pair comprises a MAC address, the MAC address identifies a WAP in a WLAN installed in a retail outlet. Where the pair comprises an SSID, the SSID identifies a group of WAPs which are comprised in a single WLAN or in plural interconnected networks, such as might belong to a retail chain. A MAC address or SSID can therefore be used to determine the appropriate marketing information for a particular retail outlet or retail chain. The operator of the advertising service also makes an application program available for download to smartphones. According to one approach a Quick Response (QR) code is provided by a retail outlet, e.g. such as on their literature or at a point of sale. When a smartphone user wishes to make use of the advertising operator's service, the user scans the QR code with the smartphone. The scanning of the QR code is operative to initiate the download and installation of the advertising operator's application program on the user's smartphone 54. The user configures by way of the application program preferences with regards to the form of marketing information to be received 56. According to a first approach, the user chooses whether to allow or block marketing information from a particular retailer. The application program is operative to convey the allow or block information to the server apparatus by way of a GSM communications channel, which is described in further detail below. The allow or block information is stored in the server apparatus 16 in a record corresponding to the user's smartphone and is used subsequently to determine whether or not marketing information is to be transmitted to the user. According to a second approach, the user enters profile information which is used to determine the kind of marketing information to be received by the user. For example the user enters age and sex details. The profile information is conveyed to the server apparatus by way of the GSM communications channel. The profile information is stored in the server apparatus 16 and used subsequently to determine the form of marketing information to be received by the user. For example, if the user has chosen to allow advertising from a particular retailer the profile information is used to select marketing information appropriate to the specified age and sex of the user. The operation of the application program is described in more detail below.

Referring again to FIG. 1 the user either passed by or enters a first retail outlet such that the user and the user's smartphone 32 are within range 34 of the first WLAN 20, which is installed in the first retail outlet's premises. The WAP 24 of the first WLAN 20 is operative to transmit a beacon message, which comprises at least one of a MAC address or SSID for the WAP 58 along with other information, such as timestamp and beacon interval, which are comprised in the beacon message in accordance with the IEEE 802.11 standard. The beacon message is received by the smartphone 32 on account of the smartphone being within range of the first WLAN 20. According to another approach, which is typically employed when there is a latency issue with beacon message handling, the smartphone 32 is operative to transmit a probe request message which is received by the WAP 24 which transmits in reply a probe response message comprising the MAC address or SSID for the WAP 58. The application program resident in the smartphone is operative transmit the received MAC address and/or SSID to the server apparatus 16, 60 by way of a GSM communications channel constituted by a GSM transceiver comprised in the smartphone 32, the base transceiver station 12, the base station controller 14 and a wired or wireless link between the base station controller 14 and the server apparatus 16. Subject to the MAC address corresponding to a retailer being indicated as allowed by the smartphone user, the server apparatus 16 is operative to match the received MAC address with a data record in the look up table stored in the data store 18, 62. In certain forms, the look up table stored MAC address corresponds to a plurality of different data records, which contain or to relate to advertising suitable for a user having different profiles. The server apparatus 16 is operative to select one of the plurality of different data records after the MAC address matching process in dependence on the user profile 62. The server is thus operative to select a data record containing or referring to an advertisement suitable for a user having the same profile as the profile of the smartphone user. The server apparatus 16 is then operative to send the matched or selected data record to the smartphone 32 by way of the GSM communications channel 64. Upon reception of the data record by the smartphone 32, the application program is operative to form an advertisement in dependence on the content of the received data record with the advertisement being displayed to the user on a display of the smartphone 66. It is to be noted that the smartphone 32 has no need to engage with the first WLAN 20 other than to receive a MAC address or SSID from the first WLAN. It is therefore unnecessary for the smartphone and first WLAN to proceed to an authentication process or association process whereby data messages can be passed between the smartphone 32 and the first WLAN 20. The smartphone 32 and first WLAN 20 therefore engage with each other only to the extent necessary to determine if the smartphone 32 is in sufficient proximity to the first retail outlet to warrant reception of an advertisement.

Subsequently the user moves such that the smartphone 32 is out of range of the first WLAN 20 and is within range of the second WLAN 22. The second WLAN 22 is installed in a second retail outlet. As described above the WLAN 22 comprises three WAPs 26, 28, 30 which together provide for greater territorial scope of wireless coverage, such as on three different floors of the second retail outlet. The second retail outlet has configured the second WLAN 22 such that each of the three WAPs 26, 28, 30 transmits the same SSID. The application program resident in the user's smartphone 32 is accordingly operative to transmit the SSID comprised in a beacon or probe response message received from one of the three WAPs 26, 28, 30 to the server apparatus 16 by way of the GSM communications channel. The server apparatus 16 is operative to match the received SSID with at least one data record contained in the look up table stored in the data store 18. Following matching or selection of a data record as described above the matched or selected data record is transmitted by way of the GSM communications channel to the user's smartphone 32 for display of an advertisement on the smartphone display. Otherwise operation is as described above with respect to the first WLAN 20.

In a second embodiment the first and second WLANs 20, 22 in FIG. 1 are installed in an entertainment or sports arena such that they cover different parts of the arena. The entertainment or sports arena also comprises third and further WLANs which are installed in yet further different locations. The server apparatus is configured to provide different public information messages to groups of persons in the different parts of the entertainment or sports arena covered by the different WLANs. More specifically a MAC address or SSID of each WLAN is stored in look up table form in the data store 18 with a respective data record comprising a public information message. A public information message associated with the first WLAN 20 might, for example, direct persons to leave by a first exit and a public information message associated with the second WLAN 22 might, for example, direct persons to leave by a second exit. The second embodiment is used, for example, to give directions to persons in the entertainment or sports arena to provide for orderly evacuation of the arena upon conclusion of an entertainment or sports event. Otherwise the form and function of the second embodiment are as described above.

In a third embodiment the first WLAN 20 is installed on a moving vehicle. As the moving vehicle passes near the user, the user's smartphone 32 comes within range of the first WLAN 20 and receives a MAC address or SSID from the WAP 24 whereby and as described above an advertisement is received by the smartphone 32 from the server apparatus 16 in dependence on transmission of the MAC address or SSID to the server apparatus. In view of the mobile nature of the first WLAN 20 the smartphone 32 need not be mobile. In certain forms of this embodiment the user's device is therefore constituted by immobile computing apparatus, such as a desktop Personal Computer (PC), which communicates with the server apparatus 16 by way of a different form of communications channel to the GSM link, such as an Ethernet link to a router for onward communication over the Internet. Nevertheless the communications channel between the immobile computing apparatus and the server apparatus still forms part of a metropolitan or wide area network. Otherwise the form and function of the third embodiment are as described above.

1. Communications apparatus comprising:
server apparatus comprised in a metropolitan or wide area network, the server apparatus being configured to store a plurality of unique identifiers and a plurality of different data records, each data record corresponding to a respective unique identifier; and
personal computing apparatus configured to communicate with: the server apparatus by way of the metropolitan or wide area network; and an access point comprised in a wireless local area network (WLAN),
the personal computing apparatus being operative to receive a unique identifier from the access point and to transmit the unique identifier to the server apparatus, and the server apparatus being operative to select a data record corresponding to the received unique identifier and to transmit the selected data record to the personal computing apparatus.

2. Communications apparatus according to claim 1 in which each data record comprises information comprehensible to an operator of the personal computing apparatus, the personal computing apparatus comprises an output device and the personal computing apparatus is configured to provide the information comprised in a data record to an operator by way of the output device.

3. Communications apparatus according to claim 1 further comprising the wireless local area network (WLAN) which comprises the access point, the unique identifier as transmitted by the access point being comprised in a wireless management message.

4. Communications apparatus according to claim 3 in which the access point is operative to transmit the wireless management message as part of an identity discovery process.

5. Communications apparatus according to claim 4 in which the access point is operative to transmit a beacon comprising the unique identifier.

6. Communications apparatus according to claim 4 in which the personal computing apparatus is operative to transmit a probe request message and the access point is operative upon reception of the probe request message to transmit a probe response message comprising the unique identifier.

7. Communications apparatus according to claim 1 in which the personal computing apparatus is operative such that there is no authentication process and no association process with the access point.

8. Communications apparatus according to claim 1 in which the unique identifier is a physical address for the access point.

9. Communications apparatus according to claim 1 in which the unique identifier comprises at least one of a Media Access Control (MAC) address and a Service Set Identifier (SSID).

10. Communications apparatus according to claim 1 which is configured such that one of the personal computing apparatus and the access point is mobile and the other is immobile.

11. Communications apparatus according to claim 1 in which the metropolitan or wide area network is wireless and the personal computing apparatus is configured for wireless communication with the metropolitan or wide area network.

12. Communications apparatus according to claim 1 in which the metropolitan or wide area network comprises a telecommunications network.

13. Communications apparatus according to claim 1 in which the personal computing apparatus is configured to be hand portable.

14. Communications apparatus according to claim 1 in which the wireless local area network (WLAN) is configured in accordance with an IEEE 802.11 standard and the personal computing apparatus is configured to communicate with the access point in accordance with the IEEE 802.11 standard.

15. Communications apparatus according to claim 1 in which the personal computing apparatus is operative in dependence on execution of a set of program instructions comprised in an application program stored in the personal computing apparatus.

16. Communications apparatus according to claim 1 in which the personal computing apparatus is configured to determine at least one characteristic of data records to be received in the personal computing apparatus from the server apparatus, the at least one characteristic being determined in dependence on user operation of the personal computing apparatus and the at least one characteristic being conveyed to the server apparatus.

17. A communications method comprising:
storing a plurality of unique identifiers and a plurality of different data records in server apparatus comprised in a metropolitan or wide area network, each data record corresponding to a respective unique identifier;
receiving in personal computing apparatus a unique identifier from an access point comprised in a wireless local area network (WLAN),
transmitting the unique identifier from the personal computing apparatus to the server apparatus by way of the metropolitan or wide area network;
selecting in the server apparatus a stored data record corresponding to the received unique identifier; and
transmitting the selected data record from the server apparatus to the personal computing apparatus.

18. A computer program comprising program instructions for causing the server apparatus and the personal computing apparatus to perform the method according to claim 17.

19. The computer program according to claim 18 comprising a first set of program instructions for causing the server apparatus to perform a part of the method and a second set of program instructions for causing the personal computing apparatus perform another part of the method.

20. The computer program according to claim 19 further comprising initiating the reception of the second set of program instructions in the personal computing apparatus by scanning a code.

21. The computer program according to claims 18 being at least one of: embodied on a record medium; embodied in a read only memory; stored in a computer memory; and carried on an electrical carrier signal.
